(19) United States
(12) Patent Application Publication
(10) Pub. No.: US 2002/0005639 A1
(43) Pub. Date: Jan. 17, 2002

(54) Airbag

(76) Inventor: Johannes-Alexander Varcus, Sprockhoevel (DE)

Correspondence Address: KATHRYN A. MARRA, DELPHI TECHNOLOGIES, INC., P.O. Box 5052, Mail Code: 480-414-420, Troy, MI, 48007-5052, US

(21) Appl. No.: 09/875,791

(22) Filed: Jun. 6, 2001

(30) Foreign Application Priority Data
Jun. 21, 2000 (DE) 10030488.5

(51) Int. Cl. B60R 21/16

(52) U.S. Cl. 280/743.1; 280/728.3

(57) ABSTRACT

An airbag has in the interior in the region of the airbag mouth a deflection device by means of which the gas flow which enters into the interior of the airbag is deflected laterally.

### TECHNICAL FIELD

The present invention relates to an airbag which is provided with an airbag mouth for connecting to a gas generator, with a deflection device with a diffuser cloth part which deflects a gas flow which enters through the airbag mouth into the interior of the airbag by more than 90° being provided in the interior of the airbag in the region of the airbag mouth.

### BACKGROUND OF THE INVENTION

An airbag of this kind is known in principle and serves for the protection of vehicle passengers in the event of an accident. In the ignition of the gas generator gas flows into the interior of the airbag, so that the latter deploys and forms a cushion for the vehicle passenger. In this it is desirable that the airbag deploys not primarily in the direction towards the vehicle passenger, but rather as laterally or radially as possible respectively in order to exclude undesirable injuries during the deployment of the airbag.

### SUMMARY OF THE INVENTION

The object of the present invention is to create an improved airbag of the initially named kind.

This object is satisfied by the features of claim 1 and in particular in that the diffuser cloth part of the deflection device is connected via a spacer cloth part to the part of the airbag which surrounds the airbag mouth. Through this it is achieved that the airbag first deploys substantially laterally or radially respectively, so that gas which flows after does not excessively deform the airbag envelope in the direction of the vehicle passenger. In this it is ensured through the spacer cloth part which is provided in accordance with the invention that the diffuser cloth part which is provided in accordance with the invention can first emerge from the housing of the airbag and then—held by the spacer cloth part—causes a deflection of the gas flow by more than 90°. In comparison with a direct securing of the diffuser cloth part in the region of the airbag mouth it was possible to achieve significantly better results with the solution in accordance with the invention.

Advantageous embodiments of the invention are described in the description, the figures and the subordinate claims.

In accordance with an advantageous embodiment one cloth part, i.e. either the diffuser cloth part or the spacer cloth part, can have lug-like web sections. Through this, outlet openings through which the deflected gas flow can emerge are created between the lug-like web sections. For example six lug-like web sections which are distributed over the periphery of the deflection device can be provided, so that through this a total of six outlet openings for the gas flow are created.

In accordance with a further advantageous embodiment both cloth parts can be substantially circular, with the spacer cloth part being provided with recesses which are distributed over its periphery and which bound the latter, with intervening lug-like web sections. In this embodiment the lug-like web sections are created in that recesses are provided at the outer periphery of the spacer cloth part. In this embodiment good results were obtained in connection with a circular diffuser cloth part.

It is particularly advantageous for the spacer cloth part to have a closed circumferential web section which borders on the airbag mouth. Through this it is ensured that the diffuser cloth part which is connected to the spacer cloth part can emerge completely from the airbag housing during the deployment of the airbag and is then located in a definite position. For this purpose the width of the web section should correspond at least to the depth of the airbag housing.

In principle either the diffuser cloth part or the spacer cloth part can be provided with the lug-like web sections.

### BRIEF DESCRIPTION OF THE DRAWINGS

In the following the present invention will be described in a purely exemplary manner with reference to an advantageous embodiment and with reference to the accompanying drawings. Shown are:

FIG. 1 is a side view of an airbag in accordance with the invention in the deployed state;

FIG. 2 is a side view of the deflection device in the deployed state;

FIG. 3 is a perspective front view of the airbag of FIG. 1; and

FIG. 4 is a perspective rear view of the deflection device of FIG. 2.

### DESCRIPTION OF THE PREFERRED EMBODIMENT

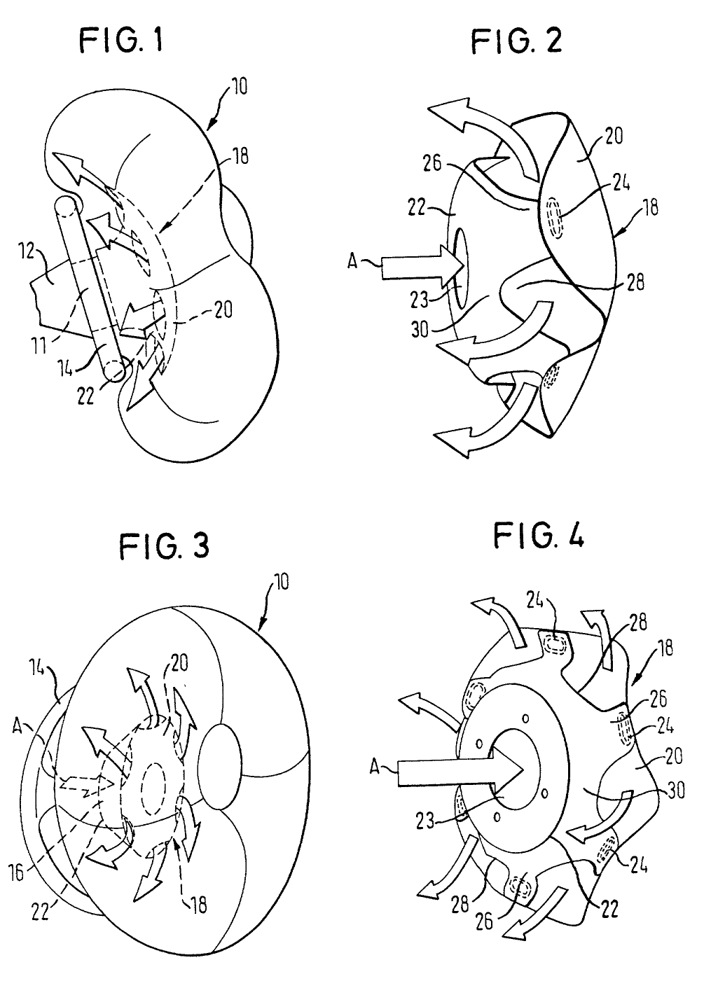

FIG. 1 shows an airbag 10 which is arranged in a steering wheel 14 which is secured to a steering column 12. The airbag 10 is accommodated in the non deployed state in an airbag module having a housing 11 and a gas generator (not illustrated).

The airbag 10 which is illustrated in FIG. 1 has a substantially cylinder-section-shaped outer contour, with an airbag mouth 16 (FIG. 3), through which the gas which is produced by the gas generator flows in into the airbag interior, being formed in the end surface of the cylinder at the steering wheel side.

In the interior of the airbag 10 a deflection device 18 which deflects the gas flow which emerges from the airbag mouth 16 laterally and by more than 90° is provided in the region of the airbag mouth 16. In other words the gas which emerges from the airbag mouth 16 can not flow directly in the direction of the front end surface of the airbag. Rather, the gas flow is first deflected or rerouted laterally and to the rear, which is indicated by corresponding arrows.

In this embodiment the deflection device 18 is formed in that a diffuser cloth part 20 is sewn together with a spacer cloth part 22 which circularly surrounds the airbag mouth 16. In plan view the spacer cloth part 22 is formed substantially circularly, with a circular passage opening 23 for the gas flow being formed centrally in the middle. The spacer cloth part 22 furthermore has lug-like web sections 26 which are distributed over its periphery and which are formed in that the fundamentally circular spacer cloth part is additionally provided at its outer periphery with recesses 28 which are distributed over the periphery and which border on the latter. In this the outer ends of the lug-like web sections 26 of the spacer cloth part 22 are folded outwards and are sewn flush with the diffuser cloth part 20, which is circular in plan view. Through this it is effected that during the deployment of the airbag the gas flow which enters into the airbag interior is first incident onto the diffuser cloth part 20 and then emerges laterally through the recesses 28. Through this the deflection device is somewhat arched during inflation, as is illustrated in the figures, and the outer edge of the diffuser cloth part 20 arches concavely relative to the plane of the airbag mouth, through which the gas flow which emerges from the deflection device 18 is deflected by more than 90° or somewhat rearwardly respectively. As in particular FIG. 4 shows, the spacer cloth part 22 has a closed circumferential web section 30, at the outer periphery of which the lug-like web sections 26 adjoin. The circumferential web section 30 serves as a spacer ring consisting of cloth in order to ensure a sufficient distance between the mounting plane of the gas generator and the diffuser cloth part 20.

The diffuser cloth part 20 is formed substantially circularly in plan view, with the diffuser cloth part 20 and the spacer cloth part 22 being sewn together through race-track-like seams 24 in such a manner that lateral outlet openings 28 can open between the diffuser cloth part 20 and the spacer cloth part 22.

As FIGS. 1 to 4 show, the direction of the gas flow is laterally or radially deflected respectively during the emergence of the gas flow from the gas generator, so that the gas flow does not flow in the direction of the vehicle passenger, but rather transversely to it and somewhat opposite to the original inflow direction. Through this the gasbag is first predominantly deployed transversely, so that an injury to the vehicle passenger is minimized. Moreover, the gasbag in accordance with the invention has shown particularly good properties in so-called out-of-position (OOP) cases, in which the vehicle passenger does not assume his usual position. If in these cases the gasbag is ignited and the deployment of the gasbag is hindered by the vehicle passenger, then the gasbag in accordance with the invention deploys in other directions, not however in the direction of the hindrance, which is desirable.

1. Airbag which is provided with an airbag mouth (16) for connecting to a gas generator, with a deflection device (18) with a diffuser cloth part (20) which deflects a gas flow which enters through the airbag mouth (16) into the interior of the airbag (10) by more than 90° being provided in the region of the airbag mouth (16),
characterized in that
the diffuser cloth part (20) of the deflection device (18) is connected via a spacer cloth part (22) to the part of the airbag (10) surrounding the airbag mouth (16).

2. Airbag in accordance with claim 1, wherein one cloth part (22) has a passage opening (23) for a gas generator.

3. Airbag in accordance with claim 1, wherein one cloth part (22) has lug-like web sections (26).

4. Airbag in accordance with claim 1, wherein both cloth parts (20, 22) are substantially circular, with the spacer cloth part (22) being provided with recesses (28) which are distributed over its periphery and which border on the latter, with intervening lug-like web sections (26).

5. Airbag in accordance with claim 1, wherein the two cloth parts (20, 22) are sewn or adhesively bonded to one another.

6. Airbag in accordance with claim 1, wherein the spacer cloth part (22) has a closed circumferential web section (30) which borders on the airbag mouth (16).

7. An airbag module comprising:
a housing
a gas generator,
an airbag having an airbag mouth for connecting to the gas generator, the airbag having a deflection device with a diffuser cloth part which deflects a gas flow which enters through the airbag mouth into the interior of the airbag, the diffuser cloth part of the deflection device being connected via a spacer cloth part to a portion of the airbag surrounding the airbag mouth, and
the spacer cloth part having a closed circumferential web section which borders on the airbag mouth, with the width of the web section corresponding at least to the depth of the housing.
